(19) United States
(12) Patent Application Publication
(10) Pub. No.: US 2020/0044241 A1
(43) Pub. Date: Feb. 6, 2020

(54) CORE-SHELL COMPOSITE PARTICLES FOR ANODE MATERIALS OF LITHIUM ION BATTERIES

(71) Applicant: Wacker Chemie AG, München (DE)

(72) Inventors: Peter Gigler, Dachau (DE); Rebecca Bernhard, München (DE); Jürgen Stohrer, Pullach (DE)

(21) Appl. No.: 16/484,029

(22) PCT Filed: Feb. 7, 2017
(86) PCT No.: PCT/EP2017/052657

§ 371 Date: Aug. 6, 2019

(51) Int. Cl. H01M 4/36; H01M 10/0525; H01M 4/134; H01M 4/1395; H01M 4/38; H01M 4/62

(52) U.S. Cl. CPC H01M 4/366; H01M 10/0525; H01M 4/134; H01M 2004/021; H01M 4/386; H01M 4/625; H01M 4/1395

(57) ABSTRACT

The invention relates to core-shell composite particles, the core being a porous, carbon-based matrix containing silicon particles and the shell being non-porous and being obtainable by the carbonization of one or more carbon precursors, the silicon particles having average particle sizes of 1 to 15 μm.

The invention relates to core-shell composite particles, wherein the core contains silicon particles and carbon and the shell is based on carbon, and also to methods for the production of the core-shell composite particles and their use in anode materials for lithium ion batteries.

As storage media for electric power, lithium ion batteries are at present the most practically useful electrochemical energy stores having the highest energy densities. Lithium ion batteries are used first and foremost in the field of portable electronics, for tools and also for electrically powered means of transport, for example bicycles or automobiles. At present, graphited carbon is most widespread as a material for the negative electrode (“anode”) of such batteries. However, a disadvantage is its relatively low electrochemical capacity of theoretically at most 372 mAh per gram of graphite, which corresponds to only about one tenth of the electrochemical capacity which is theoretically achievable using lithium metal. The development of alternative anode materials has led to use of silicon. Silicon forms binary electrochemically active alloys with lithium, which can attain very high lithium contents and, for the example of Li_{4.4}Si, theoretical specific capacities in the region of 4200 mAh per gram of silicon.

A disadvantage is that the incorporation and release of lithium into/from silicon is associated with a very large volume change which can attain about 300%. Such volume changes subject the crystallites to a great mechanical stress, for which reason the crystallites can ultimately break apart. This process, which is also referred to as electrochemical milling, leads to a loss of electrical contact in the active material and in the electrode structure and thus to destruction of the electrode with a loss of capacity.

Furthermore, the surface of the silicon anode material reacts with constituents of the electrolyte with continual formation of passivating protective layers (solid electrolyte interface; SEI). The components formed are no longer electrochemically active. The lithium bound therein is no longer available to the system, which leads to a pronounced continuous decrease in the capacity of the battery. Owing to the extreme volume change experienced by the silicon during the charging or discharging process of the battery, the SEI regularly bursts, which exposes further surfaces of the silicon anode material which are then subject to further SEI formation. Since the amount of mobile lithium in the full cell, which corresponds to the useful capacity, is limited by the cathode material, this lithium is quickly consumed and the capacity of the cell decreases to an extent which is not acceptable in use after only a few cycles.

The decrease in the capacity over the course of a number of charging and discharging cycles is referred to as fading or continuous loss of capacity and is generally irreversible.

A series of silicon-carbon composite particles in which the silicon particles are embedded in carbon matrices have been described as anode active materials for lithium ion batteries. Silicon particles having small particle sizes, for example average particle sizes d₅₀ of about 200 nm, have usually been employed here. The reason for this is that smaller silicon particles have a lower silicon uptake capacity and for this reason experience a lower volume expansion on incorporation of lithium than larger silicon particles, so that the above-described problems associated with silicon can occur to only a smaller extent. For example, the patent application having the application number DE 102016202459.0 describes composite particles comprising Si particles which have average particle sizes dos in the range from 50 to 800 nm. Specifically, Si particles having average particle sizes of 180 and 200 nm are described for this purpose.

Silicon-carbon composite particles having relatively large Si particles are of particular economic interest since they are more readily accessible by milling and can be handled more easily than small, nanosized silicon particles. However, the above-described problems such as electrochemical milling, SEI or fading represent a particular challenge for relatively large silicon particles. μm-size silicon particles having carbon coating are described, for example, in EP 1024544. The carbon coating is intended to prevent electrochemical milling and SEI formation due to its elastic properties. Porous composite particles are not described therein. US 20090208844 pursues an analogous strategy with μm-size, carbon-coated Si particles in the carbon coating of which expanded graphite, for example, is embedded. The carbon coating of the μm-size silicon particles of U.S. Pat. No. 8,394,532 also contains carbon particles such as graphite or carbon fibers. The μm-size Si particles of US 20080166474 are provided with a porous carbon coating which contains fibers and metals. US 20160172665 describes active material for lithium ion batteries, which is based on silicon particles coated with one or more identical, mesoporous carbon shells. As regards the nature of the silicon particles, US 20160172665 is unspecific in the general description; however, only aggregated silicon particles having primary particle diameters in the region of 100 nm are specifically disclosed, as can be seen from FIGS. 5A and 5B. EP 1054462 teaches various approaches for configuring anodes for lithium ion batteries. In one embodiment, μm-size silicon particles were provided with a nonporous carbon layer. In one further embodiment of EP 1054462, μm-size silicon particles are embedded in a porous carbon matrix in the electrode coating process.

In the light of this background, the object was to provide composite particles which comprise microscale silicon particles and which when used in lithium ion batteries permit a high cycling stability, more particularly leading to extremely minimal SEI formation and/or reducing the electrochemical milling. Where possible, moreover, the silicon-containing composite particles ought to possess high mechanical stability and be extremely nonbrittle.

The invention provides core-shell composite particles where the core is a porous, carbon-based matrix comprising silicon particles and

the shell is nonporous and is obtainable by carbonization of one or more carbon precursors,
where the silicon particles have average sizes (d₅₀) of from 1 to 15 μm.

The silicon particles have volume-weighted particle size distributions having diameter percentiles d₅₀ of preferably ≥1.5 μm, more preferably ≥2 μm, and particularly preferably ≥2.5 μm. The diameter percentiles d₅₀ mentioned are preferably ≤13 μm, particularly preferably ≤10 μm and most preferably ≤8 μm. The volume-weighted particle size distribution can be determined according to the invention in accordance with ISO 13320 by means of static laser light scattering using the Mie model and the measuring instrument Horiba LA 950 using ethanol as dispersing medium for the silicon particles.

The silicon particles can be present in isolated or agglomerated form, preferably not in aggregated form, in the composite particles. The silicon particles are preferably not aggregated, preferably not agglomerated and/or preferably not nanostructured.

Aggregated means that spherical or largely spherical primary particles, as are, for example, firstly formed in gas-phase processes in the production of the silicon particles, grow together during the further course of the reaction in the gas-phase process and in this way form aggregates. These aggregates can form agglomerates in the further course of the reaction. Agglomerates are a loose assembly of aggregates. Agglomerates can easily be broken up again into the aggregates by means of kneading and dispersing processes which are typically used. Aggregates cannot be broken up into the primary particles, or can be broken up only partly into the primary particles, by means of these processes. The presence of silicon particles in the form of aggregates or agglomerates can, for example, be made visible by means of conventional scanning electron microscopy (SEM). Static light scattering methods for determining the particle size distributions or particle diameters of silicon particles, on the other hand, cannot distinguish between aggregates or agglomerates.

Non-nanostructured silicon particles generally have characteristic BET surface areas. The BET surface areas of the silicon particles are preferably from 0.01 to 30.0 m²/g, more preferably from 0.1 to 25.0 m²/g, particularly preferably from 0.2 to 20.0 m²/g and most preferably from 0.2 to 18.0 m²/g. The BET surface area is determined in accordance with DIN 66131 (using nitrogen).

The silicon particles can, for example, be present in crystalline or amorphous form and are preferably not porous. The silicon particles are preferably spherical or splinter-shaped particles. As an alternative, but less preferred, the silicon particles can also have a fiber structure or be present in the form of silicon-containing films or coatings.

The silicon particles can, for example, be based on elemental silicon, silicon oxide or silicon-metal alloys. Preference is given to elemental silicon since this has the greatest storage capacity for lithium ions.

The silicon particles can preferably consist of high-purity polysilicon, but also deliberately doped silicon or metallurgical silicon which can have elemental contamination. Furthermore, it can be present alloyed with other metals and elements in the form of silicides, e.g. with metals known from the literature, for example Li, Sn, Ca, Co, Ni, Cu, Cr, Ti, Al, Fe, etc. These alloys can be binary, ternary or multinary. To increase the electrochemical storage capacity, a particularly low content of foreign elements is preferred.

The carbon-based matrix of the core-shell composite particle is porous and thus contains pores. The matrix can be considered to be a framework for the pores. The individual pores are preferably isolated. The pores are preferably not connected to one another via channels. The shape of the pores can, for example, be ellipsoidal, elongated, angular, splinter-shaped or preferably spherical.

The pore walls have a thickness of preferably from 4 to 1000 nm, particularly preferably from 24 to 900 nm and most preferably from 50 to 800 nm (method of determination: scanning electron microscopy (SEM)). The thickness of the pore walls is generally taken to be the shortest distance between two pores.

The total pore volume of the core-shell composite particles preferably corresponds to at least 2.5 times and particularly preferably at least 2.8 times and most preferably at least 3 times the volume of the silicon particles present therein. The total pore volume of the core-shell composite particles preferably corresponds at most to 4 times and particularly preferably at most to 3.7 times and most preferably at most to 3.4 times the volume of the silicon particles present therein. In an alternative embodiment, particularly if the lithium ion batteries are operated with partial lithiation, the total pore volume of the core-shell composite particles preferably corresponds to from 0.3 times to 2.4 times, particularly preferably from 0.6 times to 2.1 times and most preferably from 0.9 times to 1.8 times, the volume of the silicon particles present therein. The total pore volume per gram of composite particles is defined by the difference of the reciprocals of apparent density (determined by means of heptane pycnometry in a manner analogous to DIN 51901) and skeletal density (determined by means of He pycnometry in accordance with DIN 66137-2).

The matrix contains pores having an average diameter of preferably ≥50 nm, more preferably ≥65 nm, particularly preferably ≥70 nm and most preferably ≥100 nm. The matrix contains pores having an average diameter of preferably ≤22 μm, more preferably ≤19 μm, particularly preferably ≤15 μm and most preferably ≤12 μm.

The silicon particles can be present in the pores of the matrix (local pores) and/or outside the pores of the matrix (global pores). The Si particles are preferably present in the pores.

The global pores of the matrix have an average diameter of preferably ≥50 nm, more preferably ≥65 nm, particularly preferably ≥70 nm and most preferably ≥100 nm. The global pores of the matrix have diameters of preferably ≤6 μm, more preferably ≤5 μm, particularly preferably ≤4 μm and most preferably 3 μm.

The local pores of the matrix have an average diameter of preferably ≥1 μm, more preferably ≥1.5 μm, particularly preferably ≥2 μm and most preferably ≥2.5 μm. The local pores of the matrix have diameters of preferably ≤22 μm, more preferably ≤19 μm, particularly preferably ≤15 μm and most preferably ≤12 μm.

The determination of the pore diameters of the matrix is carried out by means of scanning electron microscopy (SEM). The measures in respect of pore diameter are preferably satisfied by the greatest diameter of two, particularly preferably three, mutually orthogonal diameters. The average diameter of the pores here is preferably the median. The volume of a silicon particle present in a pore is added to the volume of the pore in determining a pore diameter.

A pore can contain one or more silicon particles. The pores of the matrix in which silicon particles are present preferably contain ≤30, particularly preferably ≤20, even more preferably ≤10, silicon particles, in particular silicon particles having average particle sizes d₅₀ according to the invention.

The ratio of the diameters of the pores of the matrix in which silicon particles are present and the diameter of the silicon particles is preferably ≥1.1, particularly preferably ≥1.6 and most preferably ≥1.8. The above-mentioned ratio of the diameters is preferably ≤3, particularly preferably ≤2.5 and most preferably ≤2 (method of determination: scanning electron microscopy (SEM)).

The proportion of the silicon particles which are present in pores of the matrix is preferably ≥5%, more preferably ≥20%, even more preferably ≥50%, particularly preferably 80% and most preferably ≥90%, based on the total number of silicon particles in the core-shell composite particles (method of determination: scanning electron microscopy (SEM)).

The core, or the matrix, of the core-shell composite particles has volume-weighted particle size distributions having diameter percentiles d₅₀ of preferably ≥2 μm, particularly preferably ≥3 μm and most preferably ≥5 μm. The d₅₀ is preferably ≤90 μm, more preferably ≤50 μm, particularly preferably ≤30 μm and most preferably ≤20 μm. The volume-weighted particle size distribution can be determined for the purposes of the invention in accordance with ISO 13320 by means of static laser light scattering using the Mie model and the measuring instrument Horiba LA 950 using ethanol as dispersing medium for the core particles.

The matrix is generally based on carbon, in particular crystalline or amorphous carbon. Mixtures of crystalline and amorphous carbon or carbon having crystalline and amorphous subregions are also possible. The matrix generally has a spherical, for example ball-like, shape.

The matrix is preferably based on carbon to an extent of from 20 to 80% by weight, particularly preferably from 25 to 70% by weight and most preferably from 30 to 60% by weight. The matrix preferably contains from 20 to 80% by weight, particularly preferably from 30 to 75% by weight and most preferably from 40 to 70% by weight, of silicon particles. The figures in % by weight are in each case based on the total weight of the core of the core-shell composite particle.

The proportion of the core is preferably from 80 to 95% by weight and particularly preferably from 85 to 93% by weight, based on the total weight of the core-shell composite particles.

The carbon of the matrix is, for example, obtainable by carbonization of one or more carbon precursors.

Carbon precursors generally have a high carbon content and produce conductive structures on thermal conversion into carbon. The carbon yields in the carbonization of the carbon precursors are preferably ≥15%, particularly preferably ≥20% and most preferably ≥25%, based on the total weight of the carbon precursors.

Carbon precursors for the matrix are, for example, resorcinol-formaldehyde resin, phenol-formaldehyde resin, lignin or polyacrylonitrile.

The carbon produced from the carbon precursors can cover the pores in the form of a thin layer or form a matrix around the pore voids.

Furthermore, the core of the core-shell composite particles can additionally contain active materials based on the elements Li, Fe, Al, Cu, Ca, K, Na, S, Cl, Zr, Ti, Pt, Ni, Cr, Sn, Mg, Ag, Co, Zn, B, P, Sb, Pb, Ge, Bi, rare earths or combinations of these. Preferred additional active materials are based on Li and Sn. The content of additional active materials is preferably ≤1% by weight and particularly preferably ≤100 ppm, based on the total weight of the core-shell composite particles.

The core of the core-shell composite particles can optionally contain one or more conductive additives, for example graphite, (conductive) carbon black, carbon nanotubes (CNTs), fullerenes or graphene. Preferred conductive additives are conductive carbon black and carbon nanotubes. The content of conductive additives is preferably ≤1% by weight and particularly preferably ≤100 ppm, based on the total weight of the core-shell composite particles. Greatest preference is given to no conductive additives being present.

The pores of the porous matrix can, for example, be obtained by using one or more sacrificial materials for producing the matrix.

For example, porous matrices can be produced by means of mixing of one or more sacrificial materials, one or more carbon precursors and silicon particles and a subsequent carbonization stage in which the carbon precursors are at least partially converted into carbon, with the sacrificial materials being at least partially converted into pores before, during or after the carbonization.

In a preferred embodiment, the pores can be obtained by use of one or more sacrificial materials which are coated with one or more carbon precursors, with the sacrificial materials being removed again at a later point in time and the coating based on the carbon precursors being converted into a matrix based on carbon before, during or after removal of sacrificial material. In this way, too, a porous carbon matrix can be obtained.

Pores which contain silicon particles are, for example, obtainable by the silicon particles firstly being coated with one or more sacrificial materials and the resulting products being coated with one or more of the abovementioned carbon precursors and the coating based on the sacrificial materials being removed again at a later point in time, with the coating based on the carbon precursors being converted into a matrix based on carbon before or during removal of the sacrificial materials. In this way, a pore is formed around the silicon particles. The sacrificial materials can be applied in virtually any layer thicknesses in a conventional manner known per se, so as to result in core-shell composite particles having the desired pore diameters.

The coating based on the sacrificial materials has an average layer thickness in the range from preferably 4 to 300 nm, particularly preferably from 20 to 300 nm and most preferably from 50 to 100 nm (method of determination: scanning electron microscopy (SEM)). The coating based on the sacrificial materials has, at least at one point, a layer thickness of preferably from 1 to 300 nm, particularly preferably from 20 to 200 nm and most preferably from 50 to 100 nm (method of determination: scanning electron microscopy (SEM)).

Sacrificial materials can be inorganic or preferably organic in nature.

Examples of inorganic sacrificial materials are oxides, carbonates, silicates, carbides, chlorides, nitrides or sulfides of the elements silicon, magnesium, calcium, tin, zinc, titanium, nickel. Specific examples of inorganic sacrificial materials are silicon dioxide, zinc oxide, magnesium oxide, sodium chloride, magnesium carbonate and nickel sulfide. Zinc oxide or nickel sulfide can, for example, be converted by means of carbothermic reduction into volatile compounds and be liberated, and magnesium carbonate by thermal decomposition. Silicon dioxide, magnesium oxide can be leached out in a conventional way by means of acid treatment.

Typical organic sacrificial materials have a loss in mass of ≥50% by weight, preferably ≥80% by weight and particularly preferably ≥90% by weight, at a temperature selected from the range from 25 to 1000° C.

Examples of organic sacrificial materials are homopolymers or copolymers of ethylenically unsaturated monomers, e.g. polyethylene, polypropylene, polystyrene, polybutadiene, poly-tert-butoxystyrene, polyvinyl chloride, polyvinyl acetate, polymethacryl methacrylate, polyacrylic acid, polymethacrylate, polyvinyl stearate, polyvinyl laurate or copolymers thereof; polyvinyl alcohol; alkylene glycols such as ethylene glycol, butylene glycol, diethylene glycol, triethylene glycol; polyalkylene oxides such as polyethylene oxides, polypropylene oxides or copolymers thereof; gamma-butyrolactone; propylene carbonate; polysaccharides; melamine resins or polyurethanes.

Preferred sacrificial materials are polymers of ethylenically unsaturated monomers, melamine resins, polyalkylene oxides and alkylene glycols. Particularly preferred sacrificial materials are selected from the group consisting of polyethylene, polystyrene, polymethyl methacrylate, alkylene glycols and polyalkylene oxides, e.g. polyethylene oxide, polypropylene oxide and polyethylene oxide-polypropylene oxide copolymers, polyvinyl acetate, polyvinyl acetate-ethylene copolymers, polyvinyl acetate-ethylene-acrylate terpolymers, styrene-butadiene copolymers and melamine resins.

The shell of the core-shell composite particles is generally based on carbon, in particular on amorphous carbon.

The shell is generally nonporous. The carbonization of the carbon precursors according to the invention leads inevitably to the nonporous shell.

The pores of the shell are preferably <10 nm, particularly preferably ≤5 nm and most preferably ≤2 nm (method of determination: pore size distribution by the BJH method (gas adsorption) in accordance with DIN 66134).

The shell preferably has a porosity of ≤2% and particularly preferably ≤1% (method for determining the total porosity: 1 minus [ratio of apparent density (determined by means of xylene pycnometry in accordance with DIN 51901) and skeletal density (determined by means of He pycnometry in accordance with DIN 66137-2)]).

The shell preferably at least partly and particularly preferably completely envelopes the core of the core-shell composite particles. As an alternative, the shell can also fill or seal or impregnate only the pore entrances close to the surface of the core.

The shell is generally impermeable to liquid media, in particular to aqueous or organic solvents or solutions. The shell is particularly preferably impermeable to aqueous or organic electrolytes.

The liquid impermeability of the core-shell composite particles is preferably ≥95%, particularly preferably ≥96% and most preferably ≥97%. The liquid impermeability can, for example, be determined in a manner corresponding to the relevant method of determination indicated below for the examples.

Furthermore, the difference between the reciprocals of apparent density (determined by means of heptane pycnometry in a manner analogous to DIN 51901) and pure density (determined by means of He pycnometry in accordance with DIN 66137-2) gives the pore volume per gram of core-shell composite particles which is not accessible to solvent.

The proportion of the shell is preferably from 1 to 25% by weight, particularly preferably from 5 to 20% by weight and most preferably from 7 to 15% by weight, based on the total weight of the core-shell composite particles.

The shell of the core-shell composite particles is obtainable by carbonization of one or more carbon precursors for the shell.

Examples of carbon precursors for the shell are precursors which lead to hard carbon (ungraphitizable at temperatures of from 2500 to 3000° C.) or soft carbon (graphitizable at temperatures of from 2500 to 3000° C.), for example tars or pitches, in particular high-melting pitches, polyacrylonitrile or hydrocarbons having from 1 to 20 carbon atoms. Particular preference is given to mesogenic pitch, mesophase pitch, petroleum pitch and hard coal tar pitch.

Examples of hydrocarbons are aliphatic hydrocarbons having from 1 to 10 carbon atoms, in particular from 1 to 6 carbon atoms, preferably methane, ethane, propane, propylene, butane, butene, pentane, isobutane, hexane; unsaturated hydrocarbons having from 1 to 4 carbon atoms, e.g. ethylene, acetylene or propylene; aromatic hydrocarbons such as benzene, toluene, styrene, ethylbenzene, diphenylmethane or naphthalene; further aromatic hydrocarbons such as phenol, cresol, nitrobenzene, chlorobenzene, pyridine, anthracene, phenanthrene.

Preferred carbon precursors for the shell are mesogenic pitch, mesophase pitch, petroleum pitch, hard coal tar pitch, methane, ethane, ethylene, acetylene, benzene, toluene. Particular preference is given to acetylene, toluene and in particular ethylene, benzene and soft carbon from petroleum pitch or hard coal tar pitch.

The carbon precursors for the shell can, for example, be applied to the core, or to the matrix, and subsequently carbonized. Hydrocarbons having from 1 to 20 carbon atoms are preferably carbonized by the CVD process, and the other carbon precursors for the shell are preferably carbonized thermally.

The core-shell composite particles can, for example, be present as isolated particles or as loose agglomerates. The core-shell composite particles can occur in the form of splinters or flakes or preferably in spherical form.

The volume-weighted particle size distributions with diameter percentiles d₅₀ of the core-shell composite particles is preferably ≤1 mm, particularly preferably ≤50 μm and most preferably ≤20 μm, but preferably ≥1.5 μm, particularly preferably ≥3 μm and most preferably ≥5 μm.

The particle size distribution of the core-shell composite particles is preferably monomodal, but can also be bimodal or polymodal and is preferably narrow. The volume-weighted particle size distribution of the core-shell composite particles is characterized by a value of (d₉₀−d₁₀)/d₅₀ of preferably ≤2.5 and particularly preferably ≤2.

The shell or the core-shell composite particles are characterized by BET surface areas of preferably ≤50 m²/g, particularly preferably ≤25 m²/g and most preferably ≤10 m²/g (determination in accordance with DIN 66131 (using nitrogen)).

The apparent density of the core-shell composite particles is preferably ≥0.8 g/cm³, particularly preferably ≥0.9 g/cm³ and most preferably ≥1.0 g/cm³ (determined by means of heptane pycnometry in a manner analogous to DIN 51901).

The carbon present in the core-shell composite particles can be exclusively a carbon obtained by carbonization. As an alternative, further components can also be used as carbon source, for example graphite, conductive carbon black, carbon nanotubes (CNTs) or other carbon modifications. Preference is given to a high proportion of the carbon of the core-shell composite particles being obtained by carbonization, for example preferably ≥40% by weight, particularly preferably ≥70% by weight and most preferably ≥90% by weight, based on the total mass of the carbon of the core-shell composite particles.

The core-shell composite particles preferably contain from 20 to 90% by weight, particularly preferably from 25 to 85% by weight and most preferably from 30 to 80% by weight, of silicon particles. Carbon is present in an amount of preferably from 20 to 80% by weight, particularly preferably from 25 to 75% by weight and most preferably from 20 to 70% by weight, in the core-shell composite particles. Oxygen and preferably nitrogen can optionally also be present in the core-shell composite particles; these are preferably present chemically bound in the form of heterocycles, for example as pyridine and pyrrole units (N), furan (O) or oxazoles (N, O). The oxygen content of the core-shell composite particles is preferably ≤20% by weight, particularly preferably ≤10% by weight and most preferably ≤8% by weight. The nitrogen content of the core-shell composite particles is preferably in the range ≤10% by weight and particularly preferably from 0.2 to 5% by weight. The figures in percent by weight are in each case based on the total weight of a core-shell composite particle and together add up to 100% by weight.

The core-shell composite particles can optionally contain additional components, for example components based on inactive materials such as metals (e.g. copper), oxides, carbides or nitrides. The electrochemical stability can be positively influenced thereby. The proportion of inactive materials is preferably ≤10% by weight, more preferably ≤5% by weight and particularly preferably ≤1% by weight, based on the total weight of the core-shell composite particles. Greatest preference is given to no such inactive materials being present.

The invention further provides methods for the production of core-shell composite particles by
1) a) coating of silicon particles which have average particle sizes of from 1 to 15 μm with one or more sacrificial materials and/or
   b) mixing of silicon particles which have average particle sizes of from 1 to 15 μm with one or more sacrificial materials,
2) coating of the product from stage 1) with one or more carbon precursors,
3) carbonization of the product from stage 2),
   with the sacrificial materials being decomposed and liberated in this carbonization stage or in a further stage 4) to form a porous composite,
5) coating of the porous composite obtained in this way with one or more carbon precursors for the shell,
6) carbonization of the product from stage 5) and subsequently
7) optional removal of undersize or oversize particles, for example by means of typical classification techniques such as sieving or sifting.

Coating in stage 1a) can, for example, be carried out by sacrificial materials being precipitated from dispersions containing silicon particles and sacrificial materials. Here, sacrificial materials deposit on silicon particles. The silicon particles which have been coated in this way can be isolated by subsequent filtration, centrifugation and/or drying. As an alternative, the silicon particles can also be polymerized into sacrificial materials in a conventional way.

The sacrificial material for stage 1b) is preferably present in the form of particles. Sacrificial material particles can be obtained in a conventional manner by crystallization or polymerization. The sacrificial material particles for stage 1b) generally do not contain any silicon. The products from stage 1b) are generally a mixture of sacrificial material particles and silicon particles. The silicon particles generally do not bear any coating of sacrificial material particles.

Coating in stage 2) with the carbon precursors can be carried out by methods analogous to those described for stage 1a).

The carbonization in stage 3) can, for example, be carried out thermally, preferably at temperatures of from 400 to 1400° C., particularly preferably from 500 to 1100° C. and most preferably from 700 to 1000° C. The conventional reactors and other customary reaction conditions can be employed here.

The organic sacrificial material or inorganic sacrificial material, e.g. carbonates, oxides or sulfides, can be decomposed in stage 3) or in a further thermal treatment 4). As an alternative, sacrificial materials, in particular inorganic sacrificial materials such as SiO₂ or MgO, can be liberated by leaching, for example by means of hydrochloric acid, acetic acid or hydrofluoric acid, in a stage 4).

Coating in stage 5) can, in the case of the hydrocarbons having from 1 to 20 carbon atoms as carbon precursors, be carried out by conventional CVD processes. In the case of the other carbon precursors used according to the invention for the shell, the porous composite can be coated as described for stage 1a).

The carbonization in stage 6) can be carried out in a manner analogous to that described for stage 3), preferably by thermal treatment.

The individual coating or carbonization steps or stage 4) can in other respects be carried out in a manner known per se in conventional apparatuses, as will be familiar to a person skilled in the present technical field.

The present invention further provides for the use of the core-shell composite particles according to the invention in electrode materials, especially in anode materials, for lithium ion batteries, especially for producing the negative electrodes of lithium ion batteries.

The electrode materials preferably comprise one or more binders, optionally graphite, optionally one or more further electrically conductive components and optionally one or more additives, characterized in that one or more core-shell composite particles are present.

Preferred formulations for the electrode materials preferably contain from 50 to 95% by weight, in particular 60 to 85% by weight, of core-shell composite particles; from 0 to 40% by weight, in particular from 0 to 20% by weight, of further electrically conductive components; from 0 to 80% by weight, in particular from 5 to 30% by weight, of graphite; from 0 to 25% by weight, preferably from 1 to 20% by weight, particularly preferably from 5 to 15% by weight, of binders; and optionally from 0 to 80% by weight, in particular from 0.1 to 5% by weight, of additives; where the figures in percent by weight are based on the total weight of the anode material and the proportions of all constituents of the anode material add up to 100% by weight.

The invention further provides lithium ion batteries comprising a cathode, an anode, a separator and an electrolyte, characterized in that the anode comprises core-shell composite particles according to the invention.

In a preferred embodiment of the lithium ion batteries, the anode material of the fully charged lithium ion battery is only partially lithiated.

The present invention further provides methods for charging lithium ion batteries comprising a cathode, an anode, a separator and an electrolyte, characterized in that the anode comprises core-shell composite particles according to the invention; and the anode material, during the full charging of the lithium ion battery, is only partially lithiated.

The invention further provides for the use of the anode materials according to the invention in lithium ion batteries whose configuration is such that the anode materials in the fully charged state of the lithium ion batteries are only partially lithiated.

As well as the core-shell composite particles, the electrode materials and lithium ion batteries may be produced using the starting materials common for these purposes, and employing the methods customary for this purpose for producing the electrode materials and lithium ion batteries, as described, for example, in WO 2015/117838 or in the patent application having the application number DE 102015215415.7.

The lithium ion batteries are preferably constructed or configured and/or are preferably operated in such a way that the material of the anode (anode material), in particular the core-shell composite particles, is only partially lithiated in the fully charged battery. The expression fully charged refers to the state of the battery in which the anode material of the battery, in particular the core-shell composite particles, is lithiated to the greatest extent. Partial lithiation of the anode material means that the maximum lithium uptake capacity of the active material particles in the anode material, in particular the core-shell composite particles, is not exhausted.

The ratio of the lithium atoms to the silicon atoms in the anode of a lithium ion battery (Li/Si ratio) can, for example, be set via the electric charging flux. The degree of lithiation of the anode material or of the silicon particles present in the anode material is proportional to the electric charge which has flowed through. In this variant, the capacity of the anode material for lithium is not fully exhausted during charging of the lithium ion battery. This results in partial lithiation of the anode.

In an alternative, preferred variant, the Li/Si ratio of a lithium ion battery is set by means of the anode to cathode ratio (cell balancing). Here, the lithium ion batteries are designed so that the lithium uptake capacity of the anode is preferably greater than the lithium release capability of the cathode. This leads to the lithium uptake capacity of the anode not being fully exhausted, i.e. to the anode material being only partially lithiated, in the fully charged battery.

In the lithium ion battery, the ratio of the lithium capacity of the anode to the lithium capacity of the cathode (anode to cathode ratio) is preferably ≥1.15, particularly preferably ≥1.2 and most preferably ≥1.3. The expression lithium capacity here preferably refers to the utilizable lithium capacity. The utilizable lithium capacity is a measure of the capability of an electrode to store lithium reversibly. The determination of the utilizable lithium capacity can, for example, be carried out by means of half cell measurements on the electrodes in respect of lithium. The utilizable lithium capacity is determined in mAh. The utilizable lithium capacity generally corresponds to the measured delithiation capacity at a charging and discharging rate of C/2 in the voltage window from 0.8 V to 5 mV. C in C/2 here refers to the theoretical, specific capacity of the electrode coating. Details regarding the experimental procedure for determining the anode to cathode ratio may be found below for example 4 under the subheading “b) Capacity determination for setting the anode to cathode ratio (A/K)”.

The anode is preferably charged to ≤1500 mAh/g, particularly preferably ≤1400 mAh/g and most preferably ≤1300 mAh/g, based on the mass of the anode. The anode is preferably charged to at least 600 mAh/g, particularly preferably ≥700 mAh/g and most preferably ≥800 mAh/g, based on the mass of the anode. These figures preferably relate to the fully charged lithium ion battery.

The degree of lithiation of silicon or the exploitation of the capacity of silicon for lithium (Si capacity utilization α) can, for example, be determined as in the patent application having the application number DE 102015215415.7 on page 11, line 4 to page 12, line 25, in particular by means of the formula mentioned there for the Si capacity utilization α and the supplementary information under the headings “Determination of the delithiation capacity β” and “Determination of the Si proportion by weight ω_{Si}” (“incorporated by reference”).

In the case of the partial lithiation, the Li/Si ratio in the anode material in the fully charged state of the lithium ion battery is preferably ≤3.5, particularly preferably ≤3.1 and most preferably ≤2.6. The Li/Si ratio in the anode material in the fully charged state of the lithium ion battery is preferably ≥0.22, particularly preferably ≥0.44 and most preferably ≥0.66.

The capacity of the silicon of the anode material of the lithium ion battery is preferably utilized to an extent of ≤80%, particularly preferably ≤70% and most preferably ≤60%, based on a capacity of 4200 mAh per gram of silicon.

The core-shell composite particles of the invention display a significantly improved electrochemical behavior and lead to lithium-ion batteries having high volumetric capacities and excellent use properties. The shell or the core-shell composite particles are permeable to lithium ions and electrons and thus allow charge transport. The SEI in lithium ion batteries can be reduced to a large extent with the composite particles of the invention and flakes off no longer, or at least to far less of an extent, by virtue of the design of the composite particles in accordance with the invention. All of this leads to a high cycling stability on the part of corresponding lithium ion batteries. The advantageous effects are brought about by the configuration according to the invention of the core-shell composite particles. A further improvement of these advantageous effects can be achieved if the batteries are operated with partial charging. These features act in a synergistic way.

The carbon basis according to the invention of the composite particles is advantageous for the conductivity of the core-shell composite particles, thus ensuring the transport both of lithium and of the electrons to the silicon-based active material. Through direct contact between the silicon particles and the pore walls of the matrix, it is possible to accelerate the charge transport to the silicon, especially if there is a chemical attachment between the silicon particles and the matrix.

The core-shell composite particles of the invention are also surprisingly stable and mechanically robust and in particular possess a high compressive stability and a high shear stability.

Lastly, by means of the composite particle size distributions according to the invention, it is possible to improve the processability of the materials to form electrode inks and electrode coatings, and to achieve a homogeneous distribution of the particles in the electrodes.

The following examples serve to illustrate the invention:

The following analytical methods and apparatuses were used for characterization:

### Scanning Electron Microscopy (SEM/EDX):

The microscopic studies were carried out using a Zeiss Ultra 55 scanning electron microscope and an INCA x-sight energy-dispersive X-ray spectrometer. The samples were coated with carbon by vapor deposition using a Baltec SCD500 sputter/carbon coating before examination in order to prevent charging phenomena. The cross sections of the core-shell composite particles shown in the figures were produced using a Leica TIC 3× ion cutter at 6 kV.

### Inorganic Analysis/Elemental Analysis:

The C contents reported in the examples were determined using a Leco CS 230 analyzer, and a Leco TCH-600 analyzer was used to determine O and where applicable N and H contents. The qualitative and quantitative determination of other elements indicated in the core-shell composite particles obtained were carried out by means of ICP (inductively coupled plasma) emission spectrometry (Optima 7300 DV, from Perkin Elmer). The samples were for this purpose digested with acid (HF/HNO₃) in a microwave (Microwave 3000, from Anton Paar). The ICP-OES determination is based on ISO 11885 “Water quality—Determination of selected elements by inductively coupled plasma optical emission spectrometry (ICP-OES) (ISO 11885:2007); German version EN ISO 11885:2009”, which is used for examining acidic, aqueous solutions (e.g. acidified mains water, wastewater and other water samples, aqua regia extracts of soil and sediments).

### Particle Size Determination:

The determination of the particle size distribution was for the purposes of the present invention carried out in accordance with ISO 13320 by means of static laser light scattering using a Horiba LA 950. In the preparation of the samples, particular care has to be taken to ensure dispersion of the particles in the measurement solution so as not to measure the size of agglomerates instead of individual particles. In the case of the core-shell composite particles examined here, the particles were dispersed in ethanol. For this purpose, the dispersion was if necessary treated with 250 W ultrasound in a Hielscher laboratory ultrasound apparatus model UIS250v using ultrasonic probe LS24d5 for 4 minutes before the measurement.

### Surface Measurement by the BET Method:

The specific surface area of the materials was measured by gas adsorption using nitrogen on a Sorptomatic 199090 instrument (Porotec) or SA-9603MP instrument (Horiba) by the BET method.

### Si Accessibility for Liquid Media (Liquid Impermeability):

The determination of the accessibility of silicon in the core-shell composite particles for liquid media was carried out by the following test method on materials having a known silicon content (from elemental analysis):

0.5-0.6 g of core-shell composite particles were firstly dispersed by means of ultrasound in 20 ml of a mixture of NaOH (4M; H₂O) and ethanol (1:1 vol.) and subsequently stirred for 120 min at 40° C. The composite particles were filtered through a 200 nm Nylon membrane, washed with water to a neutral pH and subsequently dried at 100° C./50-80 mbar in a drying oven. The silicon content after the NaOH treatment was determined and compared to the Si content before the test. At a relative change in the Si content of ≤5%, the composite structure is considered to be impermeable (corresponds to an impermeability of ≥95%).

### Pure Density:

Pure density (=skeletal density, i.e. density of the porous solid based on the volume excluding the pore voids) was determined by means of He pycnometry in accordance with DIN 66137-2.

### Apparent Density:

The apparent density (=density of the porous solid based on the volume including the pore voids) was determined by a method based on the standard DIN 51901 “Testing of carbonaceous materials—Determination of density by the xylene method—Solid materials” by means of pycnometry on dispersions of the composite powders in heptane as an average of at least two measurements.

### Theoretical, Specific Capacity:

The theoretical, specific capacity of the core-shell composite particles obtained, as reported in the examples, was not determined experimentally but was instead calculated from the elemental composition of the materials. Here, the following capacities of the pure components were used as basis for the calculation: Si 4200 mAh/g; (amorphous) carbon 200 mAh/g; N (as part of the amorphous C matrix) 200 mAh/g. Furthermore, it was assumed in the calculation that O contents of the composites are present in the form of SiO₂ and thus reduce the contribution of the active silicon by the SiO₂ content.

The following materials were procured from commercial sources or produced in house and used directly without further purification:

Silicon powder A (splinter-like, unaggregated Si particles, d₅₀=800 nm, produced by wet milling in ethanol (solids content 20% by weight) in a stirred ball mill and subsequent drying);
Silicon powder B (splinter-like, unaggregated Si particles, d₅₀=4.5 μm, produced by dry milling in a fluidized-bed jet mill); Pitch (high-melting; softening point 235° C.).

### EXAMPLE 1

Core-Shell Composite Particles (Nonporous Shell, Core with Global Porosity, Si Particles Having d₅₀=4.5 μm):

### a) Production of Sacrificial Material Particles

20.8 g of melamine (Sigma-Aldrich # M2659) and 29.6 g of formaldehyde (Sigma-Aldrich, 252549; 80.0 g of a 37% strength solution in water) were stirred at 50° C. for one hour. 1200 ml of dilute nitric acid (pH 3.5) were then added and the mixture was stirred at 100° C. for 50 minutes. After cooling has taken place, the supernatant solution was decanted off and the solid was dried at 100° C. for 15 hours. This gave 25.9 g of spherical melamine resin particles having a diameter D50 of 1-2 μm.

b) Coating of the Silicon Particles and of the Product from Example 1a with Carbon Precursor

15 g of silicon powder B (d₅₀=4.5 μm) and 6.5 g of melamine resin particles from example 1a were dispersed by means of ultrasound (Hielscher UIS250V; amplitude 80%, cycle: 0.75; duration: 30 min), 8.2 g of resorcinol (Sigma-Aldrich, W358908) and 6.7 g of formaldehyde (18.1 g of a 37% strength solution in water) were added while stirring. The pH was subsequently set to pH 7 by addition of 4 ml of ammonia (32%) and the mixture was heated at 90° C. for four hours. After cooling, the suspension was filtered through a round filter (particle retention 20 μm), and the solid was washed with isopropanol and dried at 100° C. (80 mbar) for 15 hours. 29.8 g of a brown solid were obtained.

### c) Carbonization of the Carbon Precursor

29.8 g of the product obtained in example 1b were placed in a fused silica boat (QCS GmbH) and carbonized in a three-zone tube furnace (TFZ 12/65/550/E301; Carbolite GmbH) using cascade regulation including a type N sample element under N₂/H₂ as inert gas: heating rate 10° C./min, temperature 1000° C., hold time 180 min, N₂/H₂ flow rate 360 ml/min. After cooling, 19.4 g of a black powder were obtained.

d) Coating of the Product from Example 1c with the Carbon Precursor for the Shell

19.4 g of the product from example 1c were dispersed together with 3.9 g of pitch (high-melting; softening point 235° C.) in 350 ml of p-xylene by means of ultrasound (Hielscher UIS250V; amplitude 80%, cycle: 0.75; duration: 30 min). The suspension was stirred under reflux for 90 minutes. After cooling, the solvent was removed under reduced pressure on a rotary evaporator.

### e) Carbonization of the Carbon Precursor for the Shell

22.6 g of the product obtained in example 1d were placed in a fused silica boat (QCS GmbH) and carbonized in a three-zone tube furnace (TFZ 12/65/550/E301; Carbolite GmbH) using cascade regulation including a type N sample element under N₂/H₂ as inert gas: firstly heating rate 10° C./min, temperature 300° C.; then immediately further at heating rate 5° C./min, temperature 550° C.; then immediately further at 10° C./min, 1000° C., hold time 3 h, N₂/H₂ flow rate 360 ml/min. After cooling, 20.8 g of a black powder were obtained and this was freed of oversize by means of wet sieving. 8.8 g of porous core-shell composite particles having an impermeable outer C coating and a particle size of d₉₉<20 μm were obtained.

Elemental composition: Si 60.0% by weight; C 35.3% by weight; O 1.22% by weight; N 0.81% by weight.
Particle size distribution: monomodal; d10: 7.7 μm, d50: 12.3 μm, d90: 18.6 μm; (d90−d10)/d50=0.9;
Specific surface area (BET)=0.86 m/g;
Si impermeability: 100% (liquid-tight);
Apparent density: 1.90 g/cm³;
Pure density: 2.08 g/cm³;
Inaccessible pore volume: 0.05 cm³/g;
Theoretical, specific capacity: 2547 mAh/g.

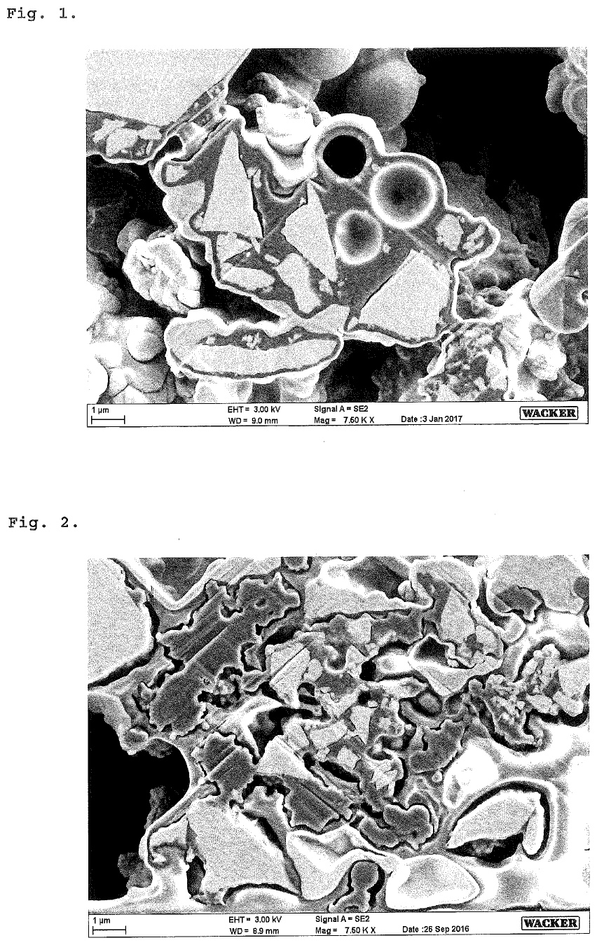

FIG. 1 shows an SEM section through core-shell composite particles from example 1e (7500× magnification). The silicon particles and macropore voids are embedded in the carbon matrix. The latter can buffer the volume expansion of silicon on lithiation of corresponding lithium ion batteries.

### EXAMPLE 2

Core-Shell Composite Particles (Nonporous Shell, Core with Local Porosity, Si Particles Having d₅₀=4.5 μm):
a) Coating of the Si with the Sacrificial Material

15.0 g of silicon powder B (d₅₀=4.5 μm) were placed in 90 ml of water and dispersed by means of ultrasound (Hielscher UIS2500V; amplitude 80%, cycle: 0.75; duration: 45 min). The suspension obtained was subsequently added at 50° C. to a solution which was likewise at 50° C. and was composed of 5.2 g of melamine and 7.4 g of formaldehyde (20.0 g of a 37% strength solution in water) and stirred at 55° C. for one hour. 300 ml of dilute nitric acid (pH 3.5) were then added and the mixture was stirred at 100° C. for 60 minutes.

b) Coating of the Product from Example 2a with Carbon Precursor

8.2 g of resorcinol and 6.7 g of formaldehyde (18.1 g of a 37% strength solution in water) were added to the product from example 2a while stirring. The pH was subsequently set to pH 7 by addition of 2 ml of ammonia (32%) and the mixture was heated at 70° C. for four hours. After cooling, the suspension was filtered through a round filter (particle retention 20 μm), and the solid was washed with isopropanol and dried at 100° C. (80 mbar) for 15 hours. 32.8 g of a brown solid were obtained.

### c) Carbonization of the Carbon Precursor

32.5 g of the product obtained in example 2b were placed in a fused silica boat (QCS GmbH) and carbonized in a three-zone tube furnace (TFZ 12/65/550/E301; Carbolite GmbH) using cascade regulation including a type N sample element under N₂/H₂ as inert gas: heating rate 10° C./min, temperature 1000° C., hold time 180 min, N₂/H₂ flow rate 360 ml/min. After cooling, 21 g of a black powder were obtained.

d) Coating of the Product from Example 2c with the Carbon Precursor for the Shell

20.2 g of the product from example 2c were dispersed together with 4.4 g of pitch (high-melting; softening point 235° C.) in 350 ml of p-xylene by means of ultrasound (Hielscher UIS250V; amplitude 80%, cycle: 0.75; duration: 30 min). The suspension was stirred under reflux for 90 min. After cooling, the solvent was removed under reduced pressure on a rotary evaporator.

### e) Carbonization of the Carbon Precursor for the Shell

21.2 g of the product obtained in example 2d were placed in a fused silica boat (QCS GmbH) and carbonized in a three-zone tube furnace (TFZ 12/65/550/E301; Carbolite GmbH) using cascade regulation including a type N sample element under N₂/H₂ as inert gas: firstly heating rate 10° C./min, temperature 300° C.; then immediately further at heating rate 5° C./min, temperature 550° C.; then immediately further at 10° C./min, 1000° C., hold time 3 h, N₂/H₂ flow rate 360 ml/min. After cooling, 19.2 g of a black powder were obtained, and this was freed of oversize by means of wet sieving. 16.6 g of porous core-shell composite particles having an impermeable outer C coating and a particle size of d₉₉<20 μm were obtained.

Elemental composition: Si 52% by weight; C 43.2% by weight; O 0.78% by weight; N 2.89% by weight;
Particle size distribution: monomodal; d10: 5.4 μm, d50: 8.4 μm, d90: 13.0 μm; (d90−d10)/d50=0.9;
specific surface area (BET)=2.7 m²/g;
Apparent density: 1.99 g/cm³;
Pure density: 2.29 g/cm³;
inaccessible pore volume: 0.07 cm³/g;
Theoretical, specific capacity: 2247 mAh/g.

FIG. 2 shows an SEM section through core-shell composite particles from example 3e (7500× magnification). The silicon particles are embedded in local macropore voids which can buffer the volume expansion of the silicon on lithiation of corresponding lithium ion batteries.

### COMPARATIVE EXAMPLE 3

Core-Shell Composite Particles (Nonporous Shell, Core with Local Porosity, Si Particles Having d₅₀=800 nm):
a) Coating of the Si with the Sacrificial Material

9.4 g of silicon powder A (d, =800 nm) were placed in 90 ml of water with addition of a few drops of ethanol and dispersed by means of ultrasound (Hielscher UIS250V; amplitude 80%, cycle: 0.75; duration: 45 min). The suspension obtained was subsequently added at 50° C. to a solution which was likewise at 50° C. and was composed of 5.2 g of melamine and 7.4 g of formaldehyde (20.0 g of a 37% strength solution in water) and the mixture was stirred at 50° C. for one hour. 300 ml of dilute nitric acid (pH 3.5) were subsequently added and the mixture was stirred at 90° C. for 50 minutes. After cooling, the suspension was filtered through a round filter (particle retention 20 μm), and the solid was washed with ethanol and dried at 100° C. (80 mbar) for 15 hours. 16.5 g of a brown solid were obtained.

b) Coating of the Product from Example 3a with Carbon Precursor

15.0 g of the product from example 3a were dispersed in 350 ml of isopropanol by means of ultrasound (Hielscher UIS250V; amplitude 80%, cycle: 0.75; duration: 30 min), and 16.1 g of resorcinol or 13.2 g of formaldehyde (35.6 g of a 37% strength solution in water) were added while stirring. The pH was subsequently set to pH 7 by addition of 5 ml of ammonia (32%) and the mixture was heated at 90° C. for four hours. After cooling, the suspension was filtered through a round filter (particle retention 20 μm), and the solid was washed with isopropanol and dried at 100° C. (80 mbar) for 15 hours. 33.4 g of a brown solid were obtained.

### c) Carbonization of the Carbon Precursor

33.6 g of the product obtained in example 3b were placed in a fused silica boat (QCS GmbH) and carbonized in a three-zone tube furnace (TFZ 12/65/550/E301; Carbolite GmbH) using cascade regulation including a type N sample element under N₂/H₂ as inert gas: heating rate 10° C./min, temperature 1000° C., hold time 180 min, N₂/H₂ flow rate 200 ml/min. After cooling, 18.9 g of a black powder were obtained.

d) Coating of the Product from Example 3c with the Carbon Precursor for the Shell

18.7 g of the product from example 3c were dispersed together with 3.7 g of pitch (high-melting; softening point 235° C.) in 350 ml of p-xylene by means of ultrasound (Hielscher UIS2500V; amplitude 80%, cycle: 0.75; duration: 30 min). The suspension was stirred under reflux for 90 min. After cooling, the solvent was removed under reduced pressure on a rotary evaporator.

### e) Carbonization of the Carbon Precursor for the Shell

18.7 g of the product obtained in example 3d were placed in a fused silica boat (QCS GmbH) and carbonized in a three-zone tube furnace (TFZ 12/65/550/E301; Carbolite GmbH) using cascade regulation including a type N sample element under N₂/H₂ as inert gas: firstly heating rate 10° C./min, temperature 300° C.; then immediately further at heating rate 5° C./min, temperature 550° C.; then immediately further at 10° C./min, 1000° C., hold time 3 h, N₂/H₂ flow rate 360 ml/min. After cooling, 20.0 g of a black powder were obtained and this was freed of oversize by means of wet sieving. 15.4 g of porous core-shell composite particles having an impermeable outer C coating and a particle size of d₉₉<20 μm were obtained.

Elemental composition: Si 33.7% by weight; C 58.9% by weight; O 4.86% by weight; N 1.18% by weight;

Particle size distribution: monomodal; d10: 11.0 μm, d50: 16.6 μm, d90: 23.8 μm; (d90−d10)/d50=0.8;
specific surface area (BET)=5.8 m²/g;
Si impermeability: 98% (liquid-tight);
Apparent density: 1.83 g/cm³;
Pure density: 2.12 g/cm³;
inaccessible pore volume: 0.08 cm³/g;
Theoretical, specific capacity: 1356 mAh/g.

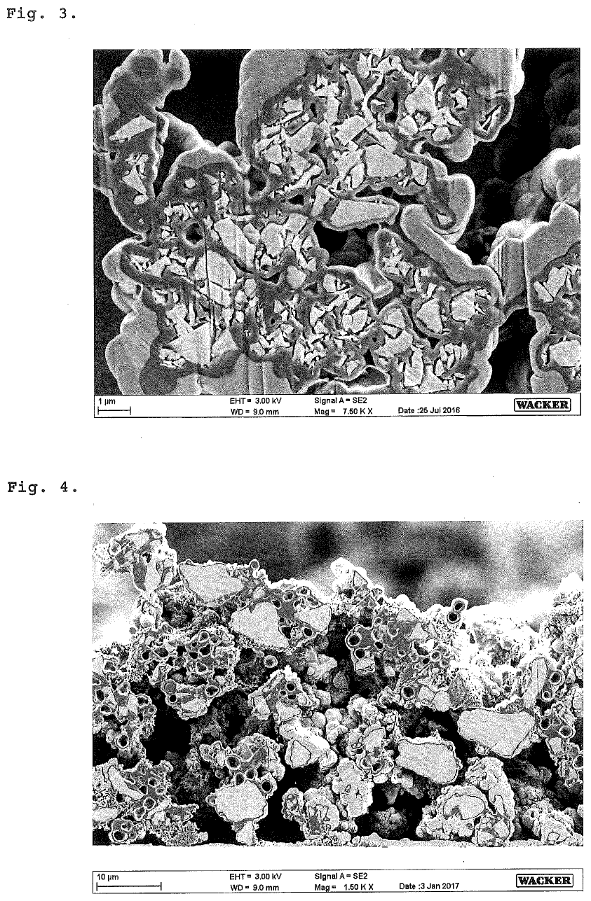

FIG. 3 shows an SEM section through a core-shell composite particle from comparative example 3e (7500× magnification). The silicon particles are embedded in local macropore voids which can buffer the volume expansion of the silicon on lithiation of corresponding lithium ion batteries.

### EXAMPLE 4

### Electrochemical Characterization of the Core-Shell Composite Particles:

a) Production of an Electrode Layer Containing the Core-Shell Composite Particle from Example 1-3:

0.17 g of conductive carbon black (Imerys, Super C65), 3.0 g of water and 6.05 g of a 1.4% strength by weight solution of sodium carboxymethyl cellulose (Daicel, Grade 1380) in water were dispersed by means of a high-speed mixer at a circumferential velocity of 4.5 m/s for 5 minutes and of 17 m/s for 30 minutes at 20° C. with cooling. 0.21 g of the SBR binder (styrene-butadiene copolymer, 40% in H₂O) was subsequently added, whereupon the mixture was dispersed again at a circumferential velocity of 17 m/s for 30 minutes. 3.0 g of the core-shell composite particles were subsequently added, stirred in at a circumferential velocity of 4.5 m/s for 5 minutes and then dispersed at a circumferential velocity of 12 m/s for a further 30 minutes. After degassing, the dispersion was applied by means of a film drawing frame having a defined gap height (Erichsen, model 360) to a copper foil (Schlenk Metallfolien, SE-Cu58) having a thickness of 0.030 mm. The electrode coating produced in this way was subsequently dried for 60 minutes at 80° C. and 1 bar atmospheric pressure.

The theoretical, specific electrode capacity of the resulting electrode is given by the theoretical, specific capacities of the electrode components which are added together weighted by their proportion by weight in the electrode. In the present case, only the core-shell composite particle contributes to the specific electrode capacity. Conductive carbon black, Na carboxymethyl cellulose and binder have no specific capacity. The theoretical, specific capacities for the various electrodes are listed in table 1.

TABLE 1
Theoretical, specific capacity of the electrodes:

| | Core-shell composite particle | | Electrode |
|---|---|---|---|
| | Theoretical, | Proportion in | Theoretical, |
| | specific capacity | the electrode | specific capacity |
| Example 1 | 2547 mAh/g | 90% by weight | 2292 mAh/g |
| Example 2 | 2247 mAh/g | 90% by weight | 2022 mAh/g |
| Example 3 | 1356 mAh/g | 90% by weight | 1220 mAh/g |

### b) Capacity Determination for Setting the Anode to Cathode Ratio (A/K):

To set the desired anode to cathode ratio in the full cell arrangement, the respective electrode coatings were firstly installed in T-cells (Swagelok T-screw fitting 316L stainless steel; ½″ tube thread; PFA seal) stamped out as working electrode (Dm=12 mm) opposite metallic lithium (Dm=12 mm; Albemarle; thickness 500 μm; battery grade) as counterelectrode (half cell).

A glass fiber filter paper (Whatman, GD Type D) impregnated with 120 μl of electrolyte served as separator (Dm=13 mm). The electrolyte used consisted of a 1.0 molar solution of lithium hexafluorophosphate (LiPF6) in a 3:7 (v/v) mixture of ethylene carbonate (EC) and diethyl carbonate (DEC), which had been admixed with 2% by weight of vinylene carbonate (VC). Assembly of the cells was carried out in a glove box (<1 ppm H₂O, O₂; MBraun); the water content in the dry matter of all components used was below 20 ppm.

The capacity measurement was carried out on a BaSyTec CTS test stand at 20° C.

The lithiation of the anode was carried out by the cc/cv (constant current/constant voltage) method using a constant current at a rate of C/25 in the first cycle and of C/2 in two subsequent cycles. The potential window for the lithiation/delithiation was set between 5 mV and 1.5 V or 0.8 V vs. lithium for C/25 or C/2. After the lower voltage limit of 5 mV versus lithium had been reached, charging was continued at constant voltage until the current went below C/100. Discharge of the cell was carried out by the cc (constant current) method using a constant current of C/25 in the first cycle and of C/2 in the two subsequent cycles until the respective upper voltage limit had been reached.

The delithiation capacity in the second discharging cycle is used as utilizable lithium capacity of the electrode.

The desired capacity of the anode coating was set by means of varying coating weights and, in combination with the cathode coating, the desired anode to cathode ratio was obtained in this way.

### c) Construction of the Li Ion Cells and Electrochemical Characterization

The electrochemical studies on full cells were carried out in a two-electrode arrangement in button cells (type CR2032, Hohsen Corp.). The electrode coating described was stamped out as counterelectrode or negative electrode (Dm=15 mm); a coating based on lithium-nickel-manganese-cobalt oxide 6:2:2 having a content of 94.0% by weight and an average weight per unit area of 14.82 mg/cm² was used as working electrode or positive electrode (Dm=15 mm). A glass fiber filter paper (Whatman, GD Type D) impregnated with 120 μl of electrolyte served as separator (Dm=16 mm). The electrolyte used consisted of a 1.0 molar solution of lithium hexafluorophosphate (LiPF₆) in a 3:7 (v/v) mixture of ethylene carbonate (EC) and diethyl carbonate (DEC), which had been admixed with 2% by weight of vinylene carbonate (VC). Construction of the cells was carried out in a glove box (<1 ppm H₂O, O₂; MBraun); the water content in the dry matter of all components used was below 20 ppm.

The electrochemical testing was carried out at 20° C. Charging of the cell was carried out by the cc/cv (constant current/constant voltage) method on a BaSyTec CTS test stand at a constant current of 5 mA/g (corresponds to C/25) in the first cycle and of 60 mA/g (corresponds to C/2) in the subsequent cycles and after the voltage limit of 4.2 V had been reached at constant voltage until the current went below 1.2 mA/g (corresponds to C/100) or 15 mA/g (corresponds to C/8). Discharge of the cell was carried out by the cc (constant current) method at a constant current of 5 mA/g (corresponds to C/25) in the first cycle and of 60 mA/g (corresponds to C/2) in the subsequent cycles until the voltage limit of 3.0 V had been reached. The specific current selected was based on the weight of the coating of the positive electrode.

Depending on the formulation, the anode to cathode ratio (cell balancing) of the lithium ion battery corresponds to complete or partial lithiation of the anode. The results of testing are summarized in table 2.

TABLE 2
Number of cycles with ≥80% capacity retention (cycle 80%):

| | Cycle 80% | | | |
|---|---|---|---|---|
| | A/K* = 1.1 | A/K* = 1.3 | A/K* = 2.0 | A/K* = 2.9 |
| Example 2 | 73 | 149 | 200 | — |
| Comparative | — | 64 | — | 96 |
| example 3 | | | | |

*Anode to cathode ratio.

The core-shell composite particles according to the invention based on Si particles having a particle diameter d₅₀ according to the invention (Example 2) have a significantly more stable cycling behavior than the core-shell composite particles based on Si particles having a particle diameter d₅₀<1 μm (comparative example 3).

Furthermore, there is a considerable increase in the cycling stability as the A/K ratio increases and thus the lithiation of the core-shell composite particle is lower.

### EXAMPLE 5

### Mechanical Stability of the Core-Shell Composite Particles:

The core-shell composite particles from example 1e were processed to an electrode as described in example 4a. Using a film drawing frame gap width of 100 μm, it was possible to achieve a dry film thickness of 34 μm for a loading of 1.79 mg/cm². This corresponds to an electrode density of 0.53 g/cm³.

A hydraulic tablet press (from Specac) was used to compress stamped electrodes (Ø15 mm) in three successive force stages (9 kN->18 kN->35 kN). As an average of three measurements it was possible to obtain a resulting electrode density of 1.12 g/cm³.

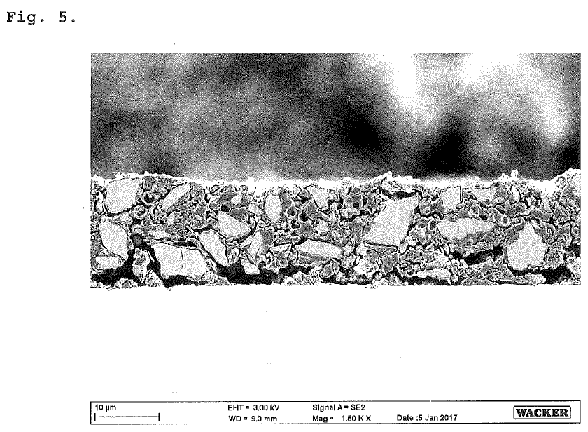

The compression is also clear in the SEM sections shown in FIG. 4 (uncompressed) and FIG. 5 (compressed). Even after the compression of the electrode (FIG. 5), the global pores in the electrode structure are clearly apparent, which suggests a high shear stability and compressive stability on the part of the core-shell composite particles according to the invention.

1. A core-shell composite particle, comprising:
a core of a porous, carbon-based matrix containing silicon particles, and
a shell, which is nonporous and obtained by carbonization of one or more carbon precursors,
wherein the silicon particles have average sizes d₅₀ of from 1.5 to 15 μm,
wherein the average particle sizes d₅₀ of the silicon particles are determined in accordance with ISO 13320 by means of static laser light scattering using the Mie model and the measuring instrument Horiba LA 950 using ethanol as dispersing medium for the silicon particles, and
wherein the core of the core-shell composite particles contain ≤1% by weight of conductive additives selected from the group consisting of graphite, carbon black, carbon nanotubes, fullerenes and graphene, based on the total weight of the core-shell composite particles.

2. The core-shell composite particle of claim 1, wherein the matrix is based on carbon which is obtained by carbonization of one or more carbon precursors selected from the group consisting of resorcinol-formaldehyde resin, phenol-formaldehyde resin, lignin and polyacrylonitrile.

3. The core-shell composite particle of claim 1, wherein one or more pores of the matrix contain silicon particles and the pores which contain silicon particles are obtained by silicon particles firstly being coated with one or more sacrificial materials and the resulting products being coated with one or more carbon precursors and the coating based on the sacrificial materials being removed again at a later point in time, with the coating based on the carbon precursors being converted into a matrix based on carbon before or during removal of the sacrificial materials.

4. The core-shell composite particle of claim 3, wherein the sacrificial materials are inorganic or organic in nature, wherein inorganic sacrificial materials comprise oxides, carbonates, carbides, nitrides or sulfides of the elements silicon, magnesium, calcium, tin, zinc, titanium or nickel, or silicates of the elements magnesium, calcium, tin, zinc, titanium or nickel and organic sacrificial materials are selected from the group consisting of polyethylene, polypropylene, polystyrene, polybutadiene, poly-tert-butoxystyrene, polyvinyl chloride, polyvinyl acetate, polymethacryl methacrylate, polyacrylic acid, polymethacrylate, polyvinyl stearate, polyvinyl laurate, polyvinyl alcohol, alkylene glycols, polyalkylene oxides, gamma-butyrolactone, propylene carbonate, polysaccharides, melamine resins and polyurethanes.

5. The core-shell composite particle of claim 1, wherein the matrix contains pores having an average diameter of from 50 nm to 22 μm, where the average diameters of the pores are determined by means of scanning electron microscopy and the average diameter is defined as the median.

6. The core-shell composite particle of claim 1, wherein the ratio of the diameters of the pores of the matrix which contain silicon particles to the diameters of the silicon particles is from 1.1 to 3, where the diameters are determined by means of scanning electron microscopy.

7. The core-shell composite particle of claim 1, wherein the shell is obtainable by carbonization of one or more carbon precursors selected from the group consisting of tars, pitches, polyacrylonitrile and hydrocarbons having from 1 to 20 carbon atoms.

8. The core-shell composite particle of claim 1, wherein any pores present in the shell are <10 nm, determined from the pore size distribution by the BJH method by means of gas adsorption in accordance with DIN 66134.

9. A method for the production of core-shell composite particles of claim 1, comprising:
1) a) coating silicon particles having average particle sizes d₅₀ of from 1.5 to 15 μm with one or more sacrificial materials and/or
b) mixing silicon particles having average particle sizes d₅₀ of from 1.5 to 15 μm with one or more sacrificial materials, where the average particle sizes d₅₀ of the silicon particles are determined in accordance with ISO 13320 by means of static laser light scattering using the Mie model and the measuring instrument Horiba LA 950 using ethanol as dispersing medium for the silicon particles,
2) coating the product from step 1) with one or more carbon precursors,
3) carbonizing the product from step 2), with the sacrificial materials being decomposed and liberated in this carbonization or in a further carbonizing step 4) to form a porous composite,
5) coating of the porous composite obtained in this way with one or more carbon precursors for the shell, and
6) carbonizing of the product from step 5).

10. A lithium ion battery comprising:
a cathode,
an anode,
a separator, and
an electrolyte,
wherein the anode is based on an anode material which comprises one or more core-shell composite particles of claim 1.

11. The lithium ion battery of claim 10,
wherein the anode material in a fully charged lithium ion battery is only partially lithiated.

12. The lithium ion battery of claim 11,
wherein the ratio of the lithium capacity of the anode to the lithium capacity of the cathode is ≥1.15.

13. The lithium ion battery of claim 11, wherein the anode in the fully charged lithium ion battery is charged with from 800 to 1500 mAh/g, based on the mass of the anode.

14. The lithium ion battery of claim 11, wherein the ratio of lithium atoms to silicon atoms in the anode material in the fully charged state of the lithium ion battery is ≤4.0.

15. The lithium ion battery of claim 11, wherein the capacity of the silicon of the anode material of the lithium ion battery is utilized to an extent of ≤80%, based on the maximum capacity of 4200 mAh per gram of silicon.
